(19) United States
(12) Patent Application Publication
(10) Pub. No.: US 2026/0341965 A1
(43) Pub. Date: Oct. 29, 2026

(54) SINGLE DIELECTRIC LAYER WIDEBAND ANTENNA ELEMENT

(71) Applicant: The United States of America, as represented by the Secretary of the Navy, Arlington, VA (US)

(72) Inventors: Jia-Chi Samuel Chieh, San Diego, CA (US); Satish Kumar Sharma, San Diego, CA (US); Raif Farkouh, San Diego, CA (US); Sanghamitro Das, San Diego, CA (US)

(73) Assignee: The United States of America, as represented by the Secretary of the Navy, Arlington, VA (US)

(21) Appl. No.: 19/186,876

(22) Filed: Apr. 23, 2025

(51) Int. Cl. H01Q 9/04; H01Q 21/06

(52) U.S. Cl. CPC H01Q 9/0435; H01Q 21/065

(57) ABSTRACT

The present invention is embodiments of circular and square patch antenna elements which may be configured as a patch antenna formed on a single dielectric layer with wideband operation, a printed circuit board embodiments and phased array antennas comprised of a matrix of the single dielectric layer wideband antenna elements exhibiting wide-angle scanning and polarization reconfigurability suitable for Ku-Band SATCOM applications.

### FEDERALLY SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, CA, 92152; voice: (619) 553-5118; email: NIWC_Pacific_T2@navy.mil. Reference Navy Case Number 212333.

### BACKGROUND OF THE INVENTION

Field of the Invention: The present invention relates generally to phased array antennas used in communications systems. More particularly, the present invention relates to a single dielectric layer wideband antenna elements, antennas and phased array antennas using such antenna elements.

Description of Related Art: For satellite communication (SATCOM) antennas, especially those used for Low Earth Orbit (LEO) constellations, phased array antennas are preferred because the movement of these satellites overhead occurs at high velocity, which requires the ground terminal antennas to track the satellites at high speeds. High velocity satellites may be difficult to track using conventional antennas mounted to a mechanical gimbal used to orient and focus on such satellites traversing the sky. In some instances, this high velocity pivoting of a gimbal mounted conventional antenna may be faster than what a mechanical gimbal is capable of and if not, then may increase the rate of failure of such mechanical systems because of the increased motion. The use of phased array antennas alleviates this problem by electronically steering the antenna and can do so at high speeds.

Flat panel phased array antennas find wide use for their ability to electronically steer beams, track multiple targets, and enhance signal strength and reliability, making them suitable for applications like radar, satellite communication (SATCOM), and 5G cellular networks. Popularity of phased array antennas is in part due to the emergence of commercial silicon beamforming chipsets along with their low-profile compact structure, light weight, high gain and the ability to perform very fast and agile electronic beam steering. For the same reasons, flat panel phased arrays have become a generally preferred solution for SATCOM platforms. Although, circular polarizations (CP) are typically employed for SATCOM applications due to their effectiveness against fading, adding flexibility in terms of polarization types enables increased redundancy. As such, the same phased array antenna technology can also be applied to other terrestrial applications where dual linear polarizations (LP) can be used.

The operating bandwidth of an antenna, commonly referred to as “fractional bandwidth” is a percentage measure of the total frequency range over which a given antenna operates. A fractional bandwidth less than 10% is generally considered narrowband. A fraction bandwidth between 10% and 60% is generally regarded as wideband. In contrast, fractional bandwidths above 60% is generally considered ultrawideband. Typical LEO SATCOM phased array antennas require greater than 10% fractional bandwidth to operate. For example, the Starlink® constellation operates at a frequency range between 10.5 and 14.5 GHz, which is a 32% fractional bandwidth. In order to support these higher bandwidths, while maintaining a planar physical form factor, patch antennas may be used.

Microstrip patch antennas are often used in flat panel phased arrays due to their low profile printed nature and favorable radiation characteristics. Nevertheless, microstrip patch antennas typically suffer from narrow impedance bandwidths. To support greater than 10% fractional bandwidth, using patch antennas, the typical method is to stack patch antennas within the vertical profile of a printed circuit board (PCB). In the stacked patch antenna configuration, one or more additional parasitic patches are arranged in close proximity to the main driven patch. The stacked patch antenna relies on multiple patches, which are stacked in a vertical fashion, in between PCB laminate layers. Each patch antenna is designed to resonate at a slightly different frequency, each overlapping, causing a wideband response. In practice, up to three stacked patch antennas can be realized for a wideband response. Such stacked patch antennas generally require at least 2 distinct PCB layers.

It is also noted that wide impedance bandwidths do not necessarily guarantee stable radiation responses for patch antennas over the entire bandwidths caused by the occurrence of higher order modes inside the operating bandwidths resulting in squinting of the beam and hence a drop in broadside gain. Special structural arrangements can be made on the stacked parasitic patch in order to push the higher order mode outside the bandwidth. The idea of differential feeding has also been explored for patch antennas to realize wideband stable radiation performances with low cross-polarizations. However, differential feeding techniques usually require complicated structural arrangements for the antenna, or sometimes even exploitation of higher order modes in order to achieve wide bandwidth that often result in radiation patterns with high sidelobes.

Stable radiation responses can also be realized during the formation of an array. This can be done by first realizing a 2×2 subarray using mirroring technique (for LP) or sequential rotation (for CP), which can then be repeated to create a larger array. Mirroring techniques and sequential rotation are also known to result in very low cross-polarizations. However, they are still prone to the adverse effects of the higher order modes mentioned earlier, which in turn can limit the operating bandwidth over which they can be successfully employed.

In view of the foregoing and for other reasons that will become evident, there exists a need in the art for improved patch antennas used in phased arrays for radio frequency (RF) communication.

### SUMMARY OF THE INVENTION

An embodiment of a circular patch antenna element formed of a conductive metal and configured for placement on a dielectric layer for use in a phased array antenna, the circular patch antenna element is disclosed. The embodiment of a circular patch antenna element may include a central circular portion, having a radius measured from a center point; 4 rectangular stubs, each rectangular stub extending perpendicularly from a radial edge of the central circular portion in north, south, east and west directions away from the center point, each rectangular stub having a stub length measured from the radial edge of the central circular portion along an associated horizontal or vertical axis to a distal stub edge, each rectangular stub further having a stub width; a left hand circular polarization port centrally located on the south rectangular stub; and a right hand circular polarization port centrally located on the east rectangular stub.

An embodiment of a circular patch antenna is disclosed. The embodiment of a circular patch antenna may include a dielectric layer having a top surface and a bottom surface; a circular patch antenna element formed of a conductive metal disposed on the top surface of the dielectric layer, the circular patch antenna element, comprising: a central circular portion, having a radius measured from a center point; 4 rectangular stubs, each rectangular stub extending perpendicularly from a radial edge of the central circular portion in north, south, east and west directions away from the center point, each rectangular stub having a stub length measured the radial edge to a distal stub edge, each rectangular stub further having a stub width; a left hand circular polarization (LHCP) port centrally located on the south rectangular stub; and a right hand circular polarization (RHCP) port centrally located on the east rectangular stub; a ground plane disposed on the bottom surface of the dielectric layer; a printed circuit board (PCB) layer adjacent to the ground plane and separated from the dielectric layer by the ground plane; first and second microstrip feed lines disposed on the PCB layer and separated from the ground plane by the PCB layer; a first feed post connected between the LHCP port and the first microstrip feed line; and a second feed post connected between the RHCP port and the second microstrip feed line.

An embodiment of a square patch antenna element formed of a conductive metal and configured for placement on a dielectric layer for use in a phased array antenna, the square patch antenna element is disclosed. The embodiment of a square patch antenna element may include a central square portion oriented along an x-y plane with center point located at an origin of the x-y plane; 4 rectangular stubs, each rectangular stub extending perpendicularly and centrally from a side of the central square portion in north (−x), south (+x), east (+y) and west (−y) directions away from the center point, each rectangular stub having a stub length measured from a central square portion edge to a distal stub edge, each rectangular stub further having a stub width; an X1 port centrally located on the south rectangular stub; an X2 port centrally located on the north rectangular stub; a Y1 port centrally located on the east rectangular stub; and a Y2 port centrally located on the west rectangular stub.

An embodiment of a square patch antenna is disclosed. The embodiment of a square patch antenna may include a dielectric layer having a top surface and a bottom surface; a square patch antenna element comprising: a central square portion oriented along an x-y plane with center point located at an origin of the x-y plane; 4 rectangular stubs, each rectangular stub extending perpendicularly and centrally from a side of the central square portion in north (−x), south (+x), east (+y) and west (−y) directions away from the center point, each rectangular stub having a stub length measured from a central square portion edge to a distal stub edge, each rectangular stub further having a stub width; an X1 port centrally located on the south rectangular stub; an X2 port centrally located on the north rectangular stub; a Y1 port centrally located on the east rectangular stub; and a Y2 port centrally located on the west rectangular stub; a ground plane disposed on the bottom surface of the dielectric layer; a printed circuit board (PCB) layer adjacent to the ground plane and separated from the dielectric layer by the ground plane; 4 microstrip feed lines disposed on the PCB layer and separated from the ground plane by the PCB layer; and 4 feed posts connecting the 4 ports to their respective one of the 4 microstrip feed lines.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 illustrates structural dimensions and features of two identical top views of a presently preferred embodiment of a circular patch antenna element, according to the present invention.

FIG. 2 is a diagram illustrating a perspective, magnified view of the circular patch antenna feed, according to the present invention.

FIG. 3 illustrates a side view cross-section of a printed circuit board (PCB) embodiment of the circular patch antenna and feed, according to the present invention.

FIGS. 4A and 4B are graphic simulations of impedance matching and polarization gains, respectively of the embodiment of a circular patch antenna, according to the present invention.

FIG. 5 is a top view of an embodiment of an 8×8 phased array antenna matrix formed of 64 circular patch antennas, according to the present invention.

FIG. 6 is a perspective view image of the top side of a printed circuit board embodiment of the 8×8 phased array antenna matrix shown in FIG. 5, illustrating the 64 circular patch antennas, according to the present invention.

FIG. 7 is a perspective view image of the bottom side of the printed circuit board embodiment of the 8×8 phased array antenna matrix shown in FIG. 6.

FIG. 8 is a graph illustrating the simulated gain and axial ratio (AR) of the 8×8 phased array antenna at 11.7 GHz, according to the present invention.

FIG. 9 is a graph illustrating the simulated gain and axial ratio (AR) of the 8×8 phased array antenna at 14.5 GHz, according to the present invention.

FIGS. 10A, 10B and 10C illustrate plan, perspective and side cross-section views, respectively of an embodiment of a square patch antenna, according to the present invention.

FIG. 11 illustrates the wideband response of the embodiment of a square patch antenna with stubs illustrated in FIGS. 10A, 10B and 10C, according to the present invention.

FIG. 12 is a top view of an embodiment of an 8×8 phased array antenna matrix formed of 64 square patch antennas, according to the present invention.

### DETAILED DESCRIPTION

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment but may be expanded for use with any of the other methods, apparatuses and systems described herein as will be understood by one of ordinary skill in the art unless specifically otherwise stated.

The present invention is a novel wideband, differentially fed, polarization-reconfigurable, element patch antenna. The design of this novel patch antenna has a very simple structure and does not employ the stacked-patch topology commonly found in prior art. The patch antenna of the present invention achieves a wide impedance bandwidth covering both the Ku-band downlink (10.7-12.7 GHz) and uplink (14-14.5 GHz) bands. The patch antenna of the present invention avoids issues related to higher order modes by using current reinforcement facilitated by a differential feeding scheme. The element patch antenna of the present invention is also capable of radiating in dual-LP and dual-CP modes, with very low cross-polarization. Accordingly, phase array configurations of these element patch antennas do not require mirroring or sequential rotation. Moreover, corresponding phased array embodiments also have a wide scanning range for both LP and CP radiations in the downlink and uplink bands. Additional detailed description of the design and the simulated performance of embodiments of a radiating patch element of the present invention, along with phased arrays embodiments follow.

### Circular Patch Antenna

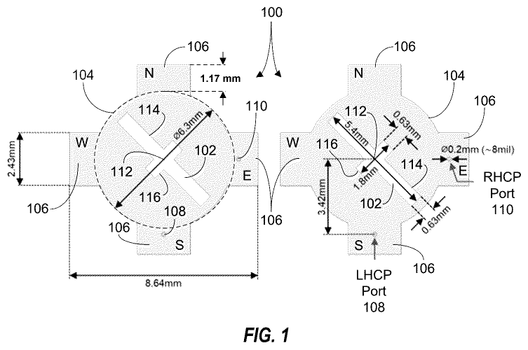

FIG. 1 illustrates structural dimensions and features of two identical plan views of a presently preferred embodiment of a circular patch antenna element 100, according to the present invention. More particularly, FIGS. 1A and 1B illustrate internal and external dimensions of the circular patch antenna element 100. The circular patch antenna element 100 may include a 45° crossed slot 102 centered in the middle of a circular patch portion 104. According to the illustrated embodiment, the circular patch portion 104 may be about 6.3 mm in diameter. A circular patch antenna by itself typically has a less than 10% impedance bandwidth. Impedance bandwidth refers to the frequency span beyond the resonant frequency of an antenna, where the impedance magnitude falls below half of the resonant value. Operating within this bandwidth ensures efficient power transfer and minimal reflection in the antenna system. The 45° crossed slot 102 helps widen the impedance bandwidth by introducing another resonant frequency. According to the illustrated embodiment, the long portion 114 of 45°crossed slot 102 is about 5.4 mm in length and about 0.63 mm in width. According to the illustrated embodiment, the short portion 116 of 45°crossed slot 102 is about 1.8 mm in length and about 0.63 mm in width.

The circular patch antenna element 100 may further include 4 rectangular stubs 106 extending from the North, South, East, and West sides of the circular patch portion 104. The ends of opposed stubs 106 extend about 8.64 mm apart, according to the illustrated embodiments of the circular patch antenna element 100. Further according to the illustrated embodiment of the circular patch antenna element 100, each stub 106 may have a width of approximately 2.43 mm. The stubs 106 provide greater movement of the feed locations, which in turn allows for flexibility in the impedance matching. These stubs 106 do increase the current path length (resonant length). The stubs 106 further stretch the impedance bandwidth at the lower frequency. Conceptually, the stubs form a larger outer diameter of the circular patch antenna element 100, which is resonant at a lower frequency.

The circular patch antenna element 100 may further include a left hand circular polarization (LHCP) port 108 on the south stub 106 and right hand circular polarization (RHCP) port 110 on the east stub 106 of each circular patch antenna element 100. More particularly, each embodiment of circular patch antenna element 100 is a dual circular polarized instantiation, i.e., the antenna may be both RHCP and LHCP. According to the illustrated embodiment, each port 108 and 110 may have a diameter of about 0.2 mm and is located a distance of about 3.42 mm from a center point of the circular patch antenna element 100. All of these design factors allow for a single dielectric layer patch antenna to have the same wideband impedance matching frequency response, as a conventional stacked patch antenna. It will be understood that the circular patch antenna element 100 may be formed of any suitable metal material, for example and not by way of limitation, copper or gold and may have any suitable thickness. It will be further understood that directional

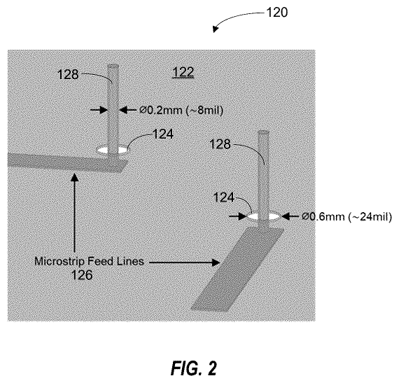

FIG. 2 is a diagram illustrating a perspective, magnified view of the circular patch antenna feed 120, according to the present invention. As shown in FIG. 2, the ground plane 122 may have vias 124 aligned with the ports 108, 110 (not shown in FIG. 2) for placement of microstrip feed lines 126 connected to feed posts 128 that passthrough but do not contact the ground plane 122. According to the illustrated embodiment of circular patch antenna feed 120, vias 124 may have a diameter of about 0.6 mm and feed posts 128 may have a cross-section diameter of about 0.2 mm. However, it will be understood that these particular dimensions are for a single embodiment of a circular patch antenna feed 120 and that other dimensions may be employed in various other embodiments consistent with the teachings of the present invention.

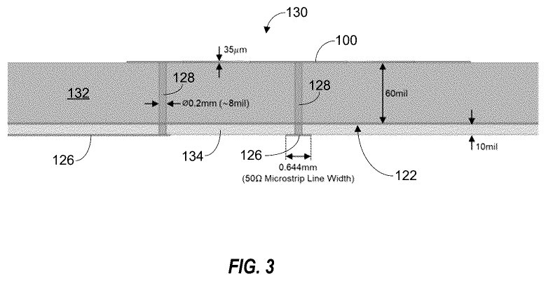

As illustrated in this particular instantiation, the circular patch antenna elements can be fed using a direct feed or using a via 124 in PCB 130 (see FIG. 3, and related discussion below) upon which the circular patch antenna 100 is constructed. It will be understood that alternative feeding mechanisms such as a proximity feed (not illustrated), or an aperture/slot feed (also not illustrated) could also be used consistent with other embodiments of the present invention. Such alternative feed mechanisms fall within the knowledge of one of ordinary skill in the art and thus will not be further elaborated herein.

FIG. 3 illustrates a side view cross-section of a printed circuit board (PCB) embodiment 130 of the circular patch antenna and feed, according to the present invention. More particularly, FIG. 3 illustrates a circular patch antenna 100 connected to the microstrip feed lines 126 and associated feed posts 128 shown in FIG. 2. FIG. 3 also illustrates the circular patch antenna 100 disposed on a primary layer of dielectric material 132 separating the antenna 100 from ground plane 122, which in turn is mounted to a PCB structural layer 132 that is also non-conducting and forms the bottom of the PCB upon which the microstrip feed lines 126 are disposed. According to the particular PCB embodiment 130 of the circular patch antenna 100 and feed illustrated in FIG. 3, the circular patch antenna 100 may have a thickness of about 25 μm, the microstrip feed lines may have a width of about 0.644 mm and impedance of 50 Ω, dielectric layer 132 may have a thickness of about 60 mil and the PCB structural layer 134 may have a thickness of about 10 mil. However, it will be understood that these particular dimensions are for a single embodiment of the circular patch antenna and feed PCB embodiment 130 and that these dimensions may be varied for various other embodiments.

Importantly, FIG. 3 illustrates that the circular patch antennas 100 of the present invention only require one single primary dielectric layer 132 to operate and not the multiple layers with parasitic antennas required of conventional vertically stacked patch antennas. According to a particular embodiment the circular patch antenna 100 shown in FIG. 3 resides on Astra® MT777 dielectric material 132, available from Isola Group, Chandler, AZ. However, it will be understood that alternative dielectric materials could also be used in other embodiments of the present invention to electrically isolate the circular patch antenna 100 from the ground plane 122, consistent with the teachings of the present invention.

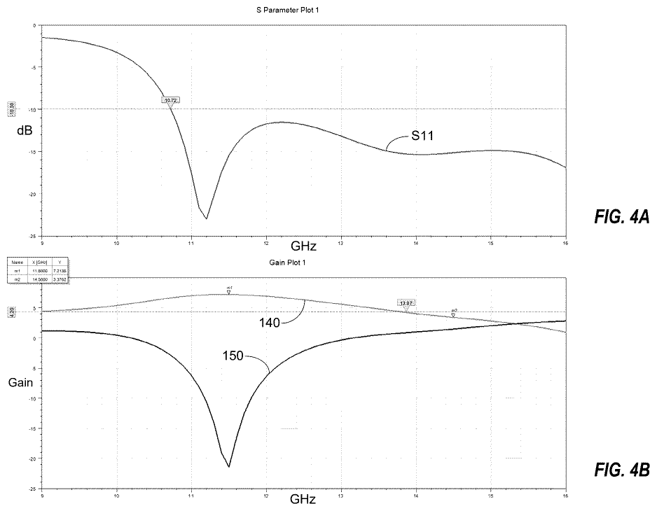

FIGS. 4A and 4B are graphic simulations of impedance matching and polarization gains, respectively of the embodiment of a circular patch antenna 100, according to the present invention. More particularly, FIG. 4a illustrates the simulated impedance matching response, also known as the S11, of the circular patch antenna 100. As shown in FIG. 4A, the S11 remains below −10 dB from about 10.7 GHz to beyond 15 GHz, showing wideband impedance matching bandwidth. FIG. 4B illustrates the simulated co-polarization 140 and cross-polarization 150 gains of the circular patch antenna 100. As can be seen, the co-polarization gain 140 of the antenna is stable across a wide frequency regime, while maintaining a high level of cross-polarization separation, i.e., cross-polarization gain 150 largely non-overlapping of co-polarization gain 140.

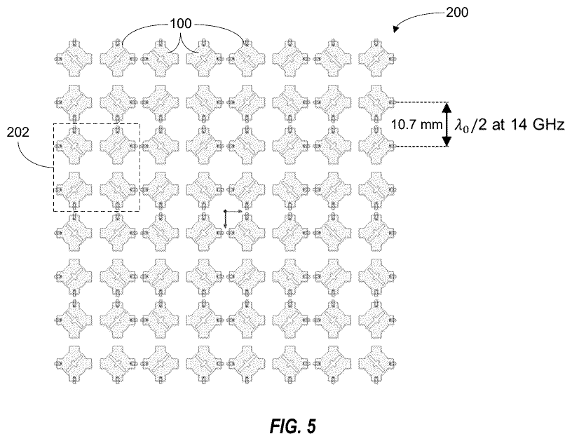

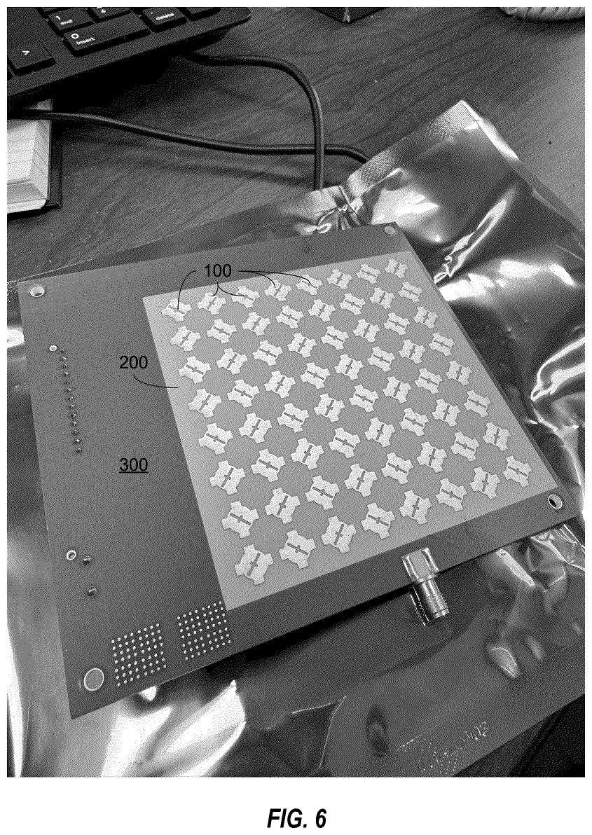

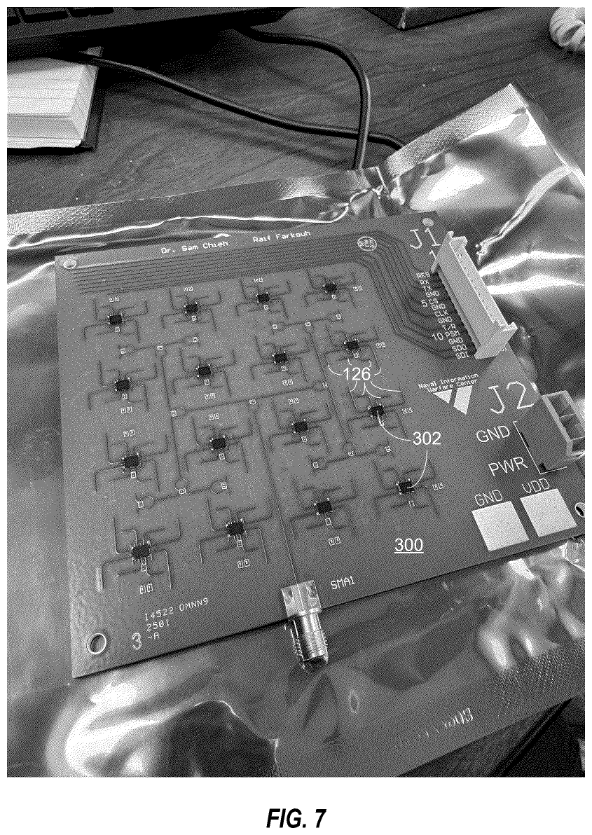

FIG. 5 is a plan view of an embodiment of an 8×8 phased array antenna matrix 200 formed of 64 circular patch antennas 100, according to the present invention. As illustrated in FIG. 5, the antenna matrix lattice spacing is λ₀/2, or about 10.7 mm at 14 GHz. It will be further noted that the circular patch antennas 100 may be further sequentially rotated 90° at the 2×2 sub-array 202 level to enhance the circular polarization (CP) bandwidth. It will be understood that according to other embodiments of the present invention, various array configurations of the novel circular patch antenna 100 may be arranged for particular applications and tuned for particular frequency responses. The 8×8 phased array 200 is merely a particular instantiation of the present invention used for illustrative purposes. It is also understood that higher order antenna systems may be constructed from the phased array antennas disclosed herein. For example, and not by way of limitation, see FIGS. 6 and 7 and related description below.

FIG. 6 is a perspective view image of the top side of a printed circuit board 300 embodiment of the 8×8 phased array antenna matrix 200 shown in FIG. 5, illustrating the 64 circular patch antennas 100, according to the present invention. It will be understood that PCB embodiment 300 of an 8×8 phased array antenna shown may be configured to connect to other antenna system components such as an RF transceiver, power source and processor to control beamforming circuitry (none of which are shown in FIG. 6).

FIG. 7 is a perspective view image of the bottom side of the PCB embodiment 300 of the 8×8 phased array antenna matrix shown in FIG. 6. FIG. 7 illustrates exemplary beamforming integrated circuits (ICs) 302 mounted to the bottom surface of the PCB 300 as well as microstrip feed lines 126 connecting to the circular patch antennas 100 on the top side (see FIG. 6). The novel circular patch antennas 100 disclosed herein may be driven by any suitable beamforming electronics, for example, and not by way of limitation, the beamforming ICs shown in FIG. 7 are Analog Devices® ADMV4680, available from Analog Devices, One Analog Way, Wilmington, MA 01887. It will be understood that the novel circular patch antennas 100 and phased array antennas 200 instantiations composed of same as disclosed herein are not dependent on the particular beamforming ICs used to drive them.

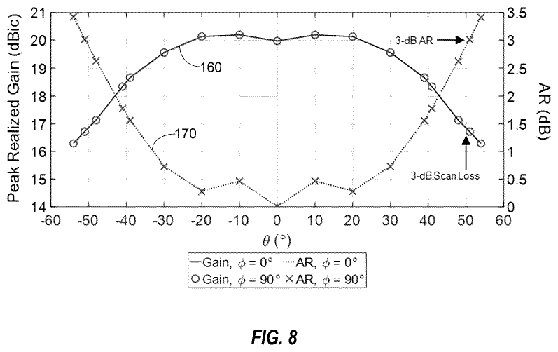

FIG. 8 is a graph illustrating the simulated gain 160 and axial ratio (AR) 170 of the phased array antenna 200 at 11.7 GHz, according to the present invention. More particularly, FIG. 8 illustrates the simulated gain 160 and AR 170 at 11.7 GHz, which shows that the phased array antenna 200 is able to scan up to ±50° with about a 3 dB gain roll-off and can also scan to about ±50° with an axial ratio of below about 3 dB. This shows that the novel antenna geometry described can support not only wide impedance bandwidths, but also wide AR 170 bandwidth for CP performance.

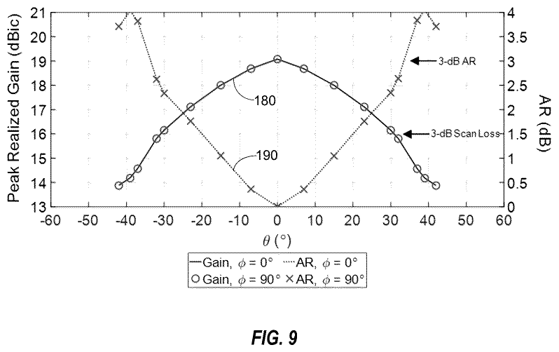

FIG. 9 is a graph illustrating the simulated gain and axial ratio (AR) of the 8×8 phased array antenna 200 at 14.5 GHz, according to the present invention. More particularly, FIG. 9 illustrates the same parameters shown in FIG. 8, namely, simulated gain 180 and AR 190, but this time at 14 GHz, the higher end of the band, which demonstrates that this topology can support wideband performance. The phased array antenna 200 can scan up to about ±35°with a 3 dB gain roll-off and a 3 dB AR. Having described a circular patch antenna 100 targeting dual-circular polarizations (LHCP and RHCP), it will be understood that the concept of a novel single layer wideband patch antenna can be extended to square patch antenna designs as follows.

### Square Patch Antenna

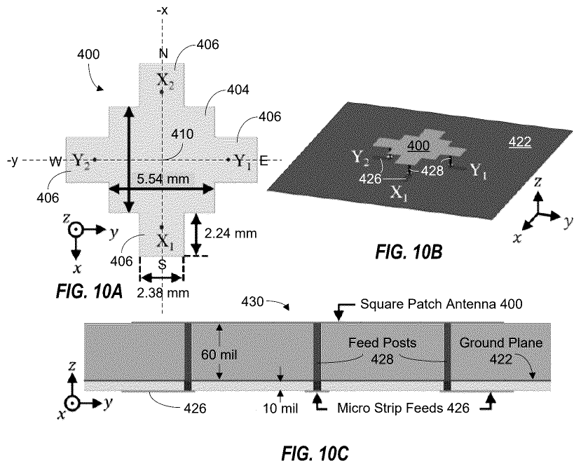

FIGS. 10A, 10B and 10C illustrate top, perspective and side cross-section views, respectively of an embodiment of a square patch antenna 400, according to the present invention. More particularly, FIG. 10A illustrates a top or plan view of the embodiment of a square patch antenna 400, with a centrally located square patch portion 404 and four rectangular stubs 406 extending from sides of the square patch portion 404 in the N, S, W, and E directions. According to the illustrated embodiment, the centrally located square patch portion 404 may have dimensions of about 5.54 mm on each side from which the stubs 406 extend in the N, S, W, and E directions. According to the illustrated embodiment of the square patch antenna element 400 each stub 406 may have a length of about 2.24 mm and a width of about 2.38 mm. It will be understood that other embodiments of the novel square patch antenna design 400 may be configured with other dimensions consistent with the teachings of the present invention. Note that this square patch antenna design 400 does not include a crossed slot feature 102 as with the circular patch antenna 100 embodiment described above.

As illustrated in FIG. 10A, the square patch antenna element 400 allows for up to 4 feed points, X₁, X₂, Y₁ and Y₂ shown in the S, N, E and W positions, respectively, on each stub 406. The stubs 406 have the effect of increasing the current path, thereby adding a resonant path at lower frequencies. Thus, the square patch antenna 400 essentially emulates two patch antennas, but instead of on separate spaced dielectric layers (i.e., the prior art), they are realized on a single layer. By using 4 feed points, X₁, X₂, Y₁ and Y₂, the square patch antenna 400 can be fed in-phase for linear polarization (LP) or orthogonal-phase for circular polarization (CP). Note that the feed points, X₁, X₂, Y₁ and Y₂, may be located on x and y axes, respectively, (see dashed lines) of an x-y plane with a center point 410 located at the origin of the x-y axes, as illustrated in FIG. 10A.

FIG. 10B illustrates a perspective view of an embodiment of a square patch antenna 400 with connected feed probes or posts 428 connected to microstrip feed lines 426 (partially hidden from view) through vias 424 passing through a ground plane 422 in much the same way as described above for the circular patch antenna 100. Though not explicitly shown in FIG. 10B, it will be understood that a primary dielectric layer 432 (see FIG. 10C) separates the square patch antenna 400 from the ground plane 422.

FIG. 10C illustrates a cross-sectional view of a PCB embodiment 430 of a square patch antenna 400, according to the present invention. As shown in FIG. 10C, the square patch antenna 400 is disposed on top of a primary dielectric layer 432 which in turn is layered on top of the ground plane 422, which in turn is layered on top of a PCB structural layer 434 separating the ground plane 422 from the micro strip feed lines 426 at the bottom of the PCB embodiment 430. According to the particular embodiment illustrated in FIG. 10C, the primary dielectric layer 432 may have a thickness of about 60 mil and the PCB structural layer 434 may have a thickness of about 10 mil.

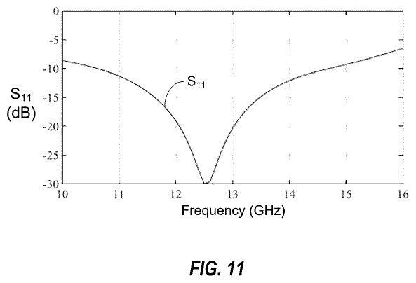

FIG. 11 illustrates the wideband response of the embodiment of a square patch antenna 400 with stubs 406 illustrated in FIGS. 10A, 10B and 10C, according to the present invention. More particularly, FIG. 11 illustrates the impedance bandwidth of the square patch antenna design 400 with the stubs 406. As illustrated in FIG. 11, the return loss, S₁₁, is less than 10 dB from about 10.6 to about 14.7 GHz. Accordingly, this square patch antenna 400 also demonstrates a wideband response while employing a single dielectric layer 432.

Additional description the square patch antenna element 400 and its higher order subsystems, e.g., as a single layer patch antenna formed on a PCB 430 and as an array of such square patch antennas configured as a phased array antenna, may be found in Das et al., “A Novel Wideband, Wide-Angle Scanning, Polarization-Reconfigurable Phased Array Antenna for Ku-Band SATCO Applications”, 2024 IEEE International Symposium on Phased Array Systems and Technology (ARRAY), October 15-18, 2024, the contents of which are hereby incorporated by reference as if fully set forth herein and for all purposes.

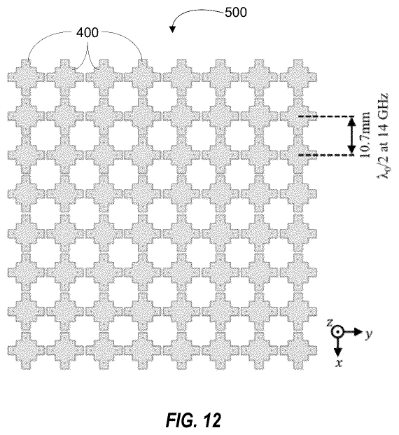

FIG. 12 is a plan view of an embodiment of an 8×8 phased array antenna matrix 500 formed of 64 square patch antennas 400, according to the present invention. As illustrated in FIG. 12, each of the square patch antennas 400 may be oriented in a matrix with lattice spacing λ₀/2 of about 10.7 mm at 14 GHz.

Having described particular embodiments of the novel circular and square patch antenna elements, PCB patch antennas and phased array antennas based on the patch antennas, additional general embodiments of the invention are described below.

An embodiment of a circular patch antenna element formed of a conductive metal and configured for placement on a dielectric layer for use in a phased array antenna is disclosed. The embodiment of a circular patch antenna element may include a central circular portion, having a radius measured from a center point. The embodiment of a circular patch antenna element may further include 4 rectangular stubs, each rectangular stub extending perpendicularly from a radial edge of the central circular portion in north, south, east and west directions away from the center point, each rectangular stub having a stub length measured from the radial edge of the central circular portion along an associated horizontal or vertical axis to a distal stub edge, each rectangular stub further having a stub width. The embodiment of a circular patch antenna element may further include a left hand circular polarization port centrally located on the south rectangular stub. The embodiment of a circular patch antenna element may further include a right hand circular polarization port centrally located on the east rectangular stub. According to a particular embodiment of a circular patch antenna element, the diameter of the central circular portion may be approximately 6.3 mm. According to another particular embodiment of a circular patch antenna element, the stub length may be approximately 1.17 mm and the stub width may be approximately 2.43 mm. According to yet another particular embodiment of a circular patch antenna element, the distance from opposed distal stub edges may be approximately 8.64 mm.

According to one embodiment, a circular patch antenna element may further include a long slot opening formed within the central circular portion and encompassing the center point, having a long slot length, a long slot width and oriented diagonally at 45° angle relative to a vertical or horizontal axis. According to a particular embodiment of a circular patch antenna element, the long slot length may be approximately 5.4 mm and the long slot width may be approximately 0.63 mm. According to another embodiment, a circular patch antenna element may further include a short diagonal slot opening formed within the central circular portion and encompassing the center point, having a short slot length, a short slot width and oriented perpendicular to and overlapping the long slot opening. According to another particular embodiment of a circular patch antenna element, the short slot length may be approximately 1.8 mm and the short slot width may be approximately 0.63 mm.

According to yet still another embodiment, the circular patch antenna element may further include a left hand circular polarization (LHCP) port centrally located in the south stub, and a right hand circular polarization (RHCP) port centrally located in the east stub. According to one particular embodiment of a circular patch antenna element, each of the ports may be located approximately 3.42 mm from the center point.

An embodiment of a circular patch antenna is disclosed. The embodiment of a circular patch antenna may include a dielectric layer having a top surface and a bottom surface. The embodiment of a circular patch antenna may further include a circular patch antenna element formed of a conductive metal disposed on the top surface of the dielectric layer. According to this particular embodiment of a circular patch antenna, the circular patch antenna element may further include a central circular portion, having a radius measured from a center point. According to this particular embodiment of a circular patch antenna, the circular patch antenna element may further include 4 rectangular stubs, each rectangular stub extending perpendicularly from a radial edge of the central circular portion in north, south, east and west directions away from the center point, each rectangular stub having a stub length measured the radial edge to a distal stub edge, each rectangular stub further having a stub width. According to this particular embodiment of a circular patch antenna, the circular patch antenna element may further include a left hand circular polarization (LHCP) port centrally located on the south rectangular stub. According to this particular embodiment of a circular patch antenna, the circular patch antenna element may further include a right hand circular polarization (RHCP) port centrally located on the east rectangular stub. The embodiment of a circular patch antenna may further include a ground plane disposed on the bottom surface of the dielectric layer. The embodiment of a circular patch antenna may further include a printed circuit board (PCB) layer adjacent to the ground plane and separated from the dielectric layer by the ground plane. The embodiment of a circular patch antenna may further include first and second microstrip feed lines disposed on the PCB layer and separated from the ground plane by the PCB layer. The embodiment of a circular patch antenna may further include a first feed post connected between the LHCP port and the first microstrip feed line. The embodiment of a circular patch antenna may further include a second feed post connected between the RHCP port and the second microstrip feed line. According to another embodiment of a circular patch antenna, the first and the second feed posts each pass through an associated via formed in the ground plane without touching the ground plane.

According to still another embodiment, a phased array of circular patch antennas is disclosed, wherein each of the circular patch antennas shares the dielectric layer, the ground plane and the PCB layer. According to a particular embodiment of a phased array of circular patch antennas, the array may include an 8×8 matrix of 64 circular patch antennas separated from each other and having center point lattice separation of approximately 10.7 mm at 14 GHz. According to another particular embodiment of a phased array of circular patch antennas, the 8×8 array of 64 circular patch antennas may further include 90° rotation of individual circular patch antennas at a 2×2 sub-array level within the 8×8 array.

An embodiment of a square patch antenna element formed of a conductive metal and configured for placement on a dielectric layer for use in a phased array antenna is disclosed. The embodiment of a square patch antenna element may include a central square portion oriented along an x-y plane with center point located at an origin of the x-y plane. The embodiment of a square patch antenna element may further include 4 rectangular stubs, each rectangular stub extending perpendicularly and centrally from a side of the central square portion in north (−x), south (+x), east (+y) and west (−y) directions away from the center point, each rectangular stub having a stub length measured from a central square portion edge to a distal stub edge, each rectangular stub further having a stub width. The embodiment of a square patch antenna element may further include an X₁ port centrally located on the south rectangular stub. The embodiment of a square patch antenna element may further include an X₂ port centrally located on the north rectangular stub. The embodiment of a square patch antenna element may further include a Y₁ port centrally located on the east rectangular stub. The embodiment of a square patch antenna element may further include a Y₂ port centrally located on the west rectangular stub. According to a particular embodiment of a square patch antenna element, each side of the central square portion may be approximately 5.54 mm in length. According to another particular embodiment of a square patch antenna element, each stub length may be approximately 2.24 mm and each stub width may be approximately 2.38 mm. According to other embodiments, the square patch antenna element may further be fed in-phase for linear polarization or may be fed orthogonal-phase for circular polarization.

An embodiment of a square patch antenna is disclosed. The embodiment of a square patch antenna may include a dielectric layer having a top surface and a bottom surface. The embodiment of a square patch antenna may further include a square patch antenna element. According to this embodiment of a square patch antenna, the square patch antenna element may include a central square portion oriented along an x-y plane with center point located at an origin of the x-y plane. According to this embodiment of a square patch antenna, the square patch antenna element may further include 4 rectangular stubs, each rectangular stub extending perpendicularly and centrally from a side of the central square portion in north (−x), south (+x), east (+y) and west (−y) directions away from the center point, each rectangular stub having a stub length measured from a central square portion edge to a distal stub edge, each rectangular stub further having a stub width. According to this embodiment of a square patch antenna, the square patch antenna element may further include an X₁ port centrally located on the south rectangular stub. According to this embodiment of a square patch antenna, the square patch antenna element may further include an X₂ port centrally located on the north rectangular stub. According to this embodiment of a square patch antenna, the square patch antenna element may further include a Y₁ port centrally located on the east rectangular stub. According to this embodiment of a square patch antenna, the square patch antenna element may further include a Y₂ port centrally located on the west rectangular stub. The embodiment of a square patch antenna may further include a ground plane disposed on the bottom surface of the dielectric layer. The embodiment of a square patch antenna may further include a printed circuit board (PCB) layer adjacent to the ground plane and separated from the dielectric layer by the ground plane. The embodiment of a square patch antenna may further include 4 microstrip feed lines disposed on the PCB layer and separated from the ground plane by the PCB layer. The embodiment of a square patch antenna may further include 4 feed posts connecting the 4 ports to their respective one of the 4 microstrip feed lines.

According to one embodiment of a square patch antenna, the 4 feed posts pass through vias formed within the ground plane without touching the ground plane. An embodiment of a phased array of square patch antennas is disclosed, wherein each of the square patch antennas shares the dielectric layer, the ground plane and the PCB layer. According to a particular embodiment of a phased array of square patch antennas, the array may include an 8×8 matrix of 64 square patch antennas separated from each other and having center point lattice separation of approximately 10.7 mm at 14 GHz.

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. It will also be understood that referential terms such as north, south, east and west are not intended to be limiting and can be rotationally translated as needed. Similarly, any planar x-y coordinates used to define the invention are also not intended to limit the invention which may be rotated or laterally translated depending on the coordinate system used.

From the above description of the embodiments of novel circular and square patch antenna elements, antennas formed of same including PCB embodiments and phased array antennas, it is manifest that various alternative structures may be used for implementing features of the present invention without departing from the scope of the claims. The embodiments described herein are to be considered in all respects as illustrative and not restrictive. It will further be understood that the present invention may suitably comprise, consist of, or consist essentially of the component parts, method steps and limitations disclosed herein. The method and/or apparatus disclosed herein may be practiced in the absence of any element that is not specifically claimed and/or disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A circular patch antenna element formed of a conductive metal and configured for placement on a dielectric layer for use in a phased array antenna, the circular patch antenna element comprising:
a central circular portion, having a radius measured from a center point;
four rectangular stubs, each rectangular stub extending perpendicularly from a radial edge of the central circular portion in north, south, east and west directions away from the center point, each rectangular stub having a stub length measured from the radial edge of the central circular portion along an associated horizontal or vertical axis to a distal stub edge, each rectangular stub further having a stub width;
a left hand circular polarization port centrally located on the south rectangular stub; and
a right hand circular polarization port centrally located on the east rectangular stub.

2. The circular patch antenna element according to claim 1, wherein a diameter of the central circular portion is about 6.3 mm.

3. The circular patch antenna element according to claim 1, wherein the stub length is about 1.17 mm and the stub width is about 2.43 mm.

4. The circular patch antenna element according to claim 1, wherein a distance from opposed distal stub edges is about 8.64 mm.

5. The circular patch antenna element according to claim 1, further comprising a long slot opening formed within the central circular portion and encompassing the center point, having a long slot length, a long slot width and oriented diagonally at 45° angle relative to a vertical or horizontal axis.

6. The circular patch antenna element according to claim 5, wherein the long slot length is about 5.4 mm and the long slot width is about 0.63 mm.

7. The circular patch antenna element according to claim 5, further comprising a short diagonal slot opening formed within the central circular portion and encompassing the center point, having a short slot length, a short slot width and oriented perpendicular to and overlapping the long slot opening.

8. The circular patch antenna element according to claim 7, wherein the short slot length is about 1.8 mm and the short slot width is about 0.63 mm.

9. The circular patch antenna element according to claim 1, further comprising:
a left hand circular polarization (LHCP) port centrally located in the south stub; and
a right hand circular polarization (RHCP) port centrally located in the east stub.

10. The circular patch antenna element according to claim 9, wherein each of the ports is located about 3.42 mm from the center point.

11. A circular patch antenna, comprising:
a dielectric layer having a top surface and a bottom surface;
a circular patch antenna element formed of a conductive metal disposed on the top surface of the dielectric layer, the circular patch antenna element, comprising:
a central circular portion, having a radius measured from a center point;
four rectangular stubs, each rectangular stub extending perpendicularly from a radial edge of the central circular portion in north, south, east and west directions away from the center point, each rectangular stub having a stub length measured the radial edge to a distal stub edge, each rectangular stub further having a stub width;
a left hand circular polarization (LHCP) port centrally located on the south rectangular stub; and
a right hand circular polarization (RHCP) port centrally located on the east rectangular stub;
a ground plane disposed on the bottom surface of the dielectric layer;
a printed circuit board (PCB) layer adjacent to the ground plane and separated from the dielectric layer by the ground plane;
first and second microstrip feed lines disposed on the PCB layer and separated from the ground plane by the PCB layer;
a first feed post connected between the LHCP port and the first microstrip feed line; and
a second feed post connected between the RHCP port and the second microstrip feed line.

12. The circular patch antenna according to claim 11, wherein the first and the second feed posts each pass through an associated via formed in the ground plane without touching the ground plane.

13. A phased array of circular patch antennas as described in claim 11, wherein each of the circular patch antennas shares the dielectric layer, the ground plane and the PCB layer.

14. The phased array of circular patch antennas according to claim 13, wherein the array comprises an 8×8 matrix of 64 circular patch antennas separated from each other and having center point lattice separation of about 10.7 mm at 14 GHz.

15. The phased array of circular patch antennas according to claim 14, wherein the 8×8 array of 64 circular patch antennas further comprises 90° rotation of individual circular patch antennas at a 2×2 sub-array level within the 8×8 array.

16. A square patch antenna element formed of a conductive metal and configured for placement on a dielectric layer for use in a phased array antenna, the square patch antenna element comprising:
a central square portion oriented along an x-y plane with center point located at an origin of the x-y plane;
four rectangular stubs, each rectangular stub extending perpendicularly and centrally from a side of the central square portion in north (−x), south (+x), east (+y) and west (−y) directions away from the center point, each rectangular stub having a stub length measured from a central square portion edge to a distal stub edge, each rectangular stub further having a stub width;
an X₁ port centrally located on the south rectangular stub;
an X₂ port centrally located on the north rectangular stub;
a Y₁ port centrally located on the east rectangular stub; and
a Y₂ port centrally located on the west rectangular stub.

17. The square patch antenna element according to claim 16, wherein each side of the central square portion is about 5.54 mm in length.

18. The square patch antenna element according to claim 16, wherein each stub length is about 2.24 mm and each stub width is about 2.38 mm.

19. The square patch antenna element according to claim 16, further fed in-phase for linear polarization, or further fed orthogonal-phase for circular polarization.

20. A square patch antenna, comprising:
a dielectric layer having a top surface and a bottom surface;
a square patch antenna element comprising:
a central square portion oriented along an x-y plane with center point located at an origin of the x-y plane;
four rectangular stubs, each rectangular stub extending perpendicularly and centrally from a side of the central square portion in north (−x), south (+x), east (+y) and west (−y) directions away from the center point, each rectangular stub having a stub length measured from a central square portion edge to a distal stub edge, each rectangular stub further having a stub width;
an X₁ port centrally located on the south rectangular stub;
an X₂ port centrally located on the north rectangular stub;
a Y₁ port centrally located on the east rectangular stub; and
a Y₂ port centrally located on the west rectangular stub;
a ground plane disposed on the bottom surface of the dielectric layer;
a printed circuit board (PCB) layer adjacent to the ground plane and separated from the dielectric layer by the ground plane;
four microstrip feed lines disposed on the PCB layer and separated from the ground plane by the PCB layer; and
four feed posts connecting the four ports to their respective one of the four microstrip feed lines.

21. The square patch antenna according to claim 20, wherein the four feed posts pass through vias formed within the ground plane without touching the ground plane.

22. A phased array of square patch antennas as described in claim 20, wherein each of the square patch antennas shares the dielectric layer, the ground plane and the PCB layer.

23. The phased array of square patch antennas according to claim 22, wherein the array comprises an 8×8 matrix of 64 square patch antennas separated from each other and having center point lattice separation of about 10.7 mm at 14 GHz.
